(19) United States
(12) Patent Application Publication
(10) Pub. No.: US 2021/0407406 A1
(43) Pub. Date: Dec. 30, 2021

(54) PIXEL CIRCUIT AND RELATED DISPLAY PANEL AND DISPLAY DEVICE

(71) Applicant: Shenzhen China Star Optoelectronics Semiconductor Display Technology Co., Ltd., Shenzhen (CN)

(72) Inventor: Suixin Zhao, Shenzhen (CN)

(21) Appl. No.: 16/644,475

(22) PCT Filed: Jan. 21, 2020
(86) PCT No.: PCT/CN2020/073427

§ 371 Date: Mar. 4, 2020

(30) Foreign Application Priority Data
Jan. 2, 2020 (CN) 202010001684.2

(51) Int. Cl. G09G 3/3233; G09G 3/3266; G09G 3/3275

(52) U.S. Cl. CPC G09G 3/3233; G09G 3/3266; G09G 2310/0278; G09G 2300/0452; G09G 3/3275

(57) ABSTRACT

A pixel circuit, a display panel and a display device are disclosed. The pixel circuit include a lighting unit comprising a sub-pixel lighting unit, a pixel driving unit comprising a sub-pixel driving unit, and a fusing unit electrically connected between the sub-pixel lighting unit and the sub-pixel driving unit. The fusing unit breaks a connection between the sub-pixel lighting unit and the sub-pixel driving unit when a current outputted by the sub-pixel driving unit is higher than a fusing current threshold. This fusing unit could be broken under a high current. Therefore, when the sub-pixel lighting unit has a bright dot issue (this often means that the current is higher than the fusing current threshold), the fusing unit is broken and thus automatically fix the bright dot. This mechanism enormously reduces the repair time of the bright dots and raises the display quality and the manufacturing efficiency.

### FIELD OF THE INVENTION

The present invention relates to a display technique, and more particularly, to a pixel circuit and its related display panel and display device.

### BACKGROUND OF THE INVENTION

In the process of manufacturing the OLED panel, the pixel circuit inevitably has defective pixels (e.g. bright dots) due to the particles or the stability of the manufacturing tools. However, the causes of defects may be complicated and thus it requires analysis to fix the problem. The analysis process may damage the panel and takes a long time. Most of the time, the bright dots are caused by the high current of the short circuit between the power VDD and the anode of the OLED.

In other words, in the manufacturing process of the conventional OLED panel, the OLED panel may have a certain number of defective pixels (such as bright dots or dark dots) and a low display quality and may require a long time to fix the defective pixels.

### SUMMARY OF THE INVENTION

One objective of an embodiment of the present invention is to provide a pixel circuit and its related display panel and display device to solve the above-mentioned issues.

According to an embodiment of the present invention, a pixel circuit is disclosed. The pixel circuit comprises: a lighting unit, comprising a sub-pixel lighting unit; a pixel driving unit, comprising a sub-pixel driving unit; and a fusing unit, electrically connected between the sub-pixel lighting unit and the sub-pixel driving unit; wherein the fusing unit breaks a connection between the sub-pixel lighting unit and the sub-pixel driving unit when a current outputted by the sub-pixel driving unit is higher than a fusing current threshold.

According to an embodiment of the present invention, a display panel is disclosed. The display panel comprises a pixel circuit. The pixel circuit comprises: a lighting unit, comprising a sub-pixel lighting unit; a pixel driving unit, comprising a sub-pixel driving unit; and a fusing unit, electrically connected between the sub-pixel lighting unit and the sub-pixel driving unit; wherein the fusing unit breaks a connection between the sub-pixel lighting unit and the sub-pixel driving unit when a current outputted by the sub-pixel driving unit is higher than a fusing current threshold.

According to an embodiment of the present invention, a display device is disclosed. The display device comprises a display panel having a pixel circuit. The pixel circuit comprises: a lighting unit, comprising a sub-pixel lighting unit; a pixel driving unit, comprising a sub-pixel driving unit; and a fusing unit, electrically connected between the sub-pixel lighting unit and the sub-pixel driving unit; wherein the fusing unit breaks a connection between the sub-pixel lighting unit and the sub-pixel driving unit when a current outputted by the sub-pixel driving unit is higher than a fusing current threshold.

In the pixel circuits of the above embodiments, the lighting unit comprises at least one sub-pixel lighting unit and the pixel driving unit comprises at least one sub-pixel driving unit. In addition, the fusing unit is connected between the sub-pixel driving unit and the anode of the sub-pixel lighting unit such that the fusing unit could break the connection between the anode of the sub-pixel lighting unit and the sub-pixel driving unit when the current outputted from the sub-pixel driving unit is higher than a fusing current threshold. This could reduce the above-mentioned issues of bright dots. The present application has a fusing unit between the anode of the sub-pixel lighting unit and the sub-pixel driving unit. This fusing unit could be broken under a high current. Therefore, when the sub-pixel lighting unit has a bright dot issue (this often means that the current is higher than the fusing current threshold), the fusing unit is broken and thus automatically fix the bright dot. This mechanism enormously reduces the repair time of the bright dots and raises the display quality and the manufacturing efficiency.

### BRIEF DESCRIPTION OF THE DRAWINGS

FIG. 1 is a diagram of a pixel circuit according to the first embodiment of the present invention.

FIG. 2 is a diagram of a pixel circuit according to the second embodiment of the present invention.

FIG. 3 is a diagram of a pixel circuit according to the third embodiment of the present invention.

FIG. 4 is a diagram of a pixel circuit according to the fourth embodiment of the present invention.

FIG. 5 is a diagram of a pixel circuit according to the fifth embodiment of the present invention.

### DETAILED DESCRIPTION OF PREFERRED EMBODIMENTS

Embodiments of the present application are illustrated in detail in the accompanying drawings, in which like or similar reference numerals refer to like or similar elements or elements having the same or similar functions throughout the specification. The embodiments described below with reference to the accompanying drawings are exemplary and are intended to be illustrative of the present application, and are not to be construed as limiting the scope of the present application.

It is understood that terminologies, such as “center,” “longitudinal,” “horizontal,” “length,” “width,” “thickness,” “upper,” “lower,” “before,” “after,” “left,” “right,” “vertical,” “horizontal,” “top,” “bottom,” “inner,” “outer,” “clockwise,” and “counterclockwise,” are locations and positions regarding the figures. These terms merely facilitate and simplify descriptions of the embodiments instead of indicating or implying the device or components to be arranged on specified locations, to have specific positional structures and operations. These terms shall not be construed in an ideal or excessively formal meaning unless it is clearly defined in the present specification. In addition, the term “first”, “second” are for illustrative purposes only and are not to be construed as indicating or imposing a relative importance or implicitly indicating the number of technical features indicated. Thus, a feature that limited by “first”, “second” may expressly or implicitly include at least one of the features. In the description of the present disclosure, the meaning of “plural” is two or more, unless otherwise specifically defined.

All of the terminologies containing one or more technical or scientific terminologies have the same meanings that persons skilled in the art understand ordinarily unless they are not defined otherwise. For example, “arrange,” “couple,” and “connect,” should be understood generally in the embodiments of the present disclosure. For example, “firmly connect,” “detachablely connect,” and “integrally connect” are all possible. It is also possible that “mechanically connect,” “electrically connect,” and “mutually communicate” are used. It is also possible that “directly couple,” “indirectly couple via a medium,” and “two components mutually interact” are used.

The invention is described below in detail with reference to the accompanying drawings, wherein like reference numerals are used to identify like elements illustrated in one or more of the figures thereof, and in which exemplary embodiments of the invention are shown. This invention may, however, be embodied in many different forms and should not be construed as limited to the particular embodiments set forth herein. Rather, these embodiments are provided so that this disclosure will be thorough and complete, and will fully convey the scope of the invention to those skilled in the art.

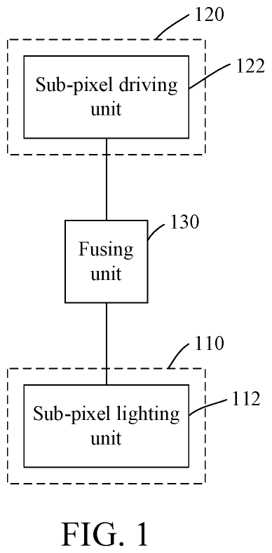

A pixel circuit, a display panel, and a display device according to embodiments of the present invention in conjunction with FIGS. 1-5 are introduced as below.

As previously mentioned, the conventional OLED panel may have a certain number of defective pixels (such as bright dots or dark dots) and a low display quality and may require a long time to fix the defective pixels. In order to solve the above-mentioned issues, a pixel circuit is disclosed as shown in FIG. 1. The pixel circuit comprises a lighting unit 110, a pixel driving unit 120 and a fusing unit 130. The lighting unit 110 comprises at least one sub-pixel lighting unit 112. The pixel driving unit 120 comprises at least one sub-pixel driving unit 122. The fusing unit 130 is connected between the sub-pixel driving unit 122 and the anode of the sub-pixel lighting unit 112. When the current outputted from the sub-pixel driving unit 122 is higher than the fusing current threshold, the fusing unit 130 is broken.

The lighting unit 110 is a device, a unit, or a module capable of generating light. The lighting unit 110 could comprise at least one sub-pixel lighting unit 112. The position of each sub-pixel lighting unit 112 in the lighting unit 110 could be arranged according to the actual demands. The sub-pixel lighting unit 112 could be a lighting device/module corresponding to a sub-pixel. For example, the sub-pixel lighting unit 112 could be a lighting unit corresponding to any one of the RGB sub-pixels. The pixel driving unit 120 could be used to drive the lighting unit to generate light. For example, the pixel driving unit 120 could output a current driving signal and transfers the current driving signal to the lighting unit 110 such that the lighting unit 110 could generate light according to the current driving signal. The pixel driving unit 120 could comprise at least one sub-pixel driving unit 122. The position of each sub-pixel driving unit 122 in the pixel driving unit 120 could be arranged according to the actual demands. Please note, the number of the sub-pixel driving units 122 and the number of the sub-pixel lighting units 112 are the same. In addition, each of the sub-pixel driving units 122 is connected to each of the sub-pixel lighting units 112 in a one-to-one correspondence.

The fusing unit 130 is a device, which is broken when a high current passes through the fusing unit 130. The fusing unit 130 is automatically broken when the current passing through the fusing unit 130 is higher than a fusing current threshold. Because the fusing unit 130 is connected between the sub-pixel driving unit 122 and the anode of the sub-pixel lighting unit 112, when the current outputted from the sub-pixel driving unit 122 is higher than the fusing current threshold, the fusing unit 130 is broken to break the connection between the sub-pixel driving unit 122 and the anode of the sub-pixel lighting unit 112. This could prevent the bright dots.

The lighting unit 110 comprises at least one sub-pixel lighting unit 112. The pixel driving unit 120 comprises at least one sub-pixel driving unit 122. The fusing unit 130 is connected between the sub-pixel driving unit 122 and the anode of the sub-pixel lighting unit 112. Therefore, when the current outputted from the sub-pixel driving unit 122 is higher than the fusing current threshold, the fusing unit 130 is broken to break the connection between the sub-pixel driving unit 122 and the anode of the sub-pixel lighting unit 112. This could eliminate the influence of the bright dots.

In the above embodiment, the fusing unit is connected between the sub-pixel driving unit and the anode of the sub-pixel lighting unit such that the fusing unit could break the connection between the anode of the sub-pixel lighting unit and the sub-pixel driving unit when the current outputted from the sub-pixel driving unit is higher than a fusing current threshold. Thus, this mechanism automatically fixes the bright dots, enormously reduces the repair time of the bright dots and raises the display quality and the manufacturing efficiency.

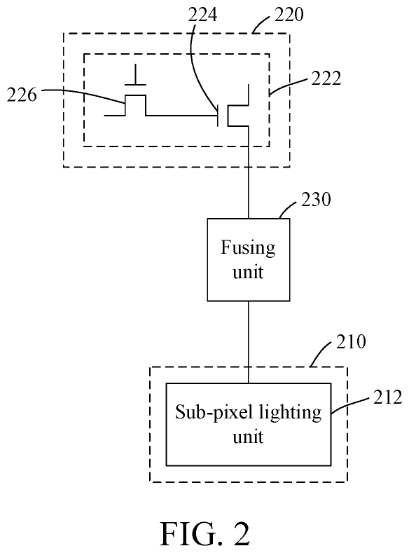

As shown in FIG. 2, a pixel circuit is disclosed. The pixel circuit comprises a lighting unit 210, a pixel driving unit 220, and a fusing unit 230. The lighting unit 210 comprises at least one sub-pixel lighting unit 212. The pixel driving unit 220 comprises at least one sub-pixel driving unit 222. The fusing unit 230 is connected between the sub-pixel driving unit 222 and the anode of the sub-pixel lighting unit 212. When the current outputted from the sub-pixel driving unit 222 is higher than the fusing current threshold, the fusing unit 230 is broken to break the connection between the sub-pixel driving unit 222 and the anode of the sub-pixel lighting unit 212.

The sub-pixel driving unit 222 comprises a driving TFT 224. The drain of the driving TFT 224 is electrically connected to the anode of the sub-pixel lighting 212 through the fusing unit.

Specifically, the driving TFT 224 represents a TFT, which could be used to drive the sub-pixel lighting unit to generate light.

Furthermore, because the drain of the driving TFT 224 is electrically connected to the anode of the sub-pixel lighting 212 through the fusing unit, when the driving TFT 224 is turned on by its gate, the driving TFT 224 could transform the power voltage signal received from through its source into a current signal. The current signal is then outputted from the drain of the TFT to the anode of the sub-pixel lighting unit 212 through the fusing unit 230 to drive the sub-pixel lighting unit 212 to generate light. When the current signal is higher than the fusing current threshold, the fusing unit 230 is automatically broken to break the connection between the anode of the sub-pixel lighting unit 212 and the driving TFT 224. This could prevent the bright dots, eliminate the influences of the bright dots, enormously reduce the repair time of the bright dots and raise the display quality and the manufacturing efficiency.

As shown in FIG. 2, the sub-pixel driving unit 222 further comprises a switch driving TFT 226. The drain of the switch driving TFT 226 is connected to the gate of the driving TFT 224. The source of the switch driving TFT 226 is used to receive a data signal and the gate of the switch driving TFT 226 is used to receive a scan signal.

The switch driving TFT 226 represents a TFT, which is used to control the on/off state of the driving TFT.

Specifically, because the drain of the switch driving TFT 226 is connected to the gate of the driving TFT 224, the source of the switch driving TFT 226 is used to receive a data signal and the gate of the switch driving TFT 226 is used to receive a scan signal, when the scan signal corresponds to a high voltage level, the switch TFT 226 is turned on and thus the data signal is transferred to the gate of the driving TFT 224. Thus, the data signal turns on the driving TFT 224. As previously mentioned, at this time, the driving TFT 224 transforms the power voltage signal into the current signal. The current signal is then outputted from the drain of the TFT to the anode of the sub-pixel lighting unit 212 through the fusing unit 230 to drive the sub-pixel lighting unit 212 to generate light. When the current signal is higher than the fusing current threshold, the fusing unit 230 is automatically broken to break the connection between the anode of the sub-pixel lighting unit 212 and the driving TFT 224. This could prevent the bright dots, eliminate the influences of the bright dots, enormously reduce the repair time of the bright dots and raise the display quality and the manufacturing efficiency.

In an embodiment, the scan signal could be transferred to the gate of the switch driving TFT through scan lines. The data signal could be transferred to the source of the switch driving TFT through data lines. In addition, in an embodiment, the sub-pixel driving unit is a 2T1C driving unit or a 3T1C driving unit.

Specifically, the 2T1C driving unit represents a sub-pixel driving unit having two TFTs and one capacitor. The 3T1C driving unit represents a sub-pixel driving unit having three TFTs and one capacitor.

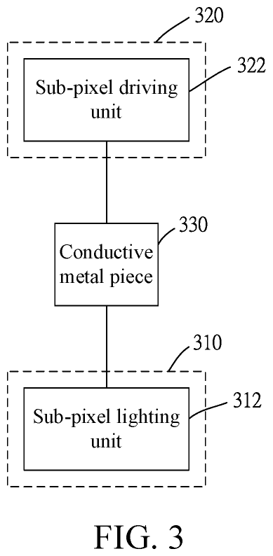

As shown in FIG. 3, a pixel circuit is disclosed. The pixel circuit comprises a lighting unit 310, a pixel driving unit 320, and a fusing unit. The lighting unit 310 comprises at least one sub-pixel lighting unit 312. The pixel driving unit 320 comprises at least one sub-pixel driving unit 322. The fusing unit is connected between the sub-pixel driving unit 322 and the anode of the sub-pixel lighting unit 312. When the current outputted from the sub-pixel driving unit 322 is higher than the fusing current threshold, the fusing unit is broken to break the connection between the sub-pixel driving unit 322 and the anode of the sub-pixel lighting unit 312. In this embodiment, the fusing unit is a highly conductive metal piece 330.

Specifically, the highly conductive metal piece 330 represents a metal piece that is broken when a high current passes through the metal piece. According to its high current characteristic, the highly conductive metal piece 330 is automatically broken when the current passing through the highly conductive metal piece 330 is higher than a fusing current threshold.

Furthermore, because the highly conductive metal piece 330 is connected between the sub-pixel driving unit 322 and the anode of the sub-pixel lighting unit 312, when the current outputted from the sub-pixel driving unit 322 is higher than the fusing current threshold, the highly conductive metal piece 330 is broken to break the connection between the sub-pixel driving unit 322 and the anode of the sub-pixel lighting unit 312. This could prevent the bright dots and eliminate the influences of the bright dots.

In the above embodiment, the highly conductive metal piece is connected between the sub-pixel driving unit and the anode of the sub-pixel lighting unit such that the highly conductive metal piece could break the connection between the anode of the sub-pixel lighting unit and the sub-pixel driving unit when the current outputted from the sub-pixel driving unit is higher than a fusing current threshold. Thus, this mechanism automatically fixes the bright dots and enormously reduces the repair time of the bright dots. The highly conductive metal piece between the sub-pixel driving unit and the anode of the sub-pixel lighting unit is equal to an additional mask. Because the current corresponding to the bright dots is higher, the highly conductive metal piece could be broken to break the connection between the anode of the sub-pixel lighting unit and the sub-pixel driving unit. Thus, this mechanism automatically fixes the bright dots, enormously reduces the repair time of the bright dots, and raises the display quality and the manufacturing efficiency.

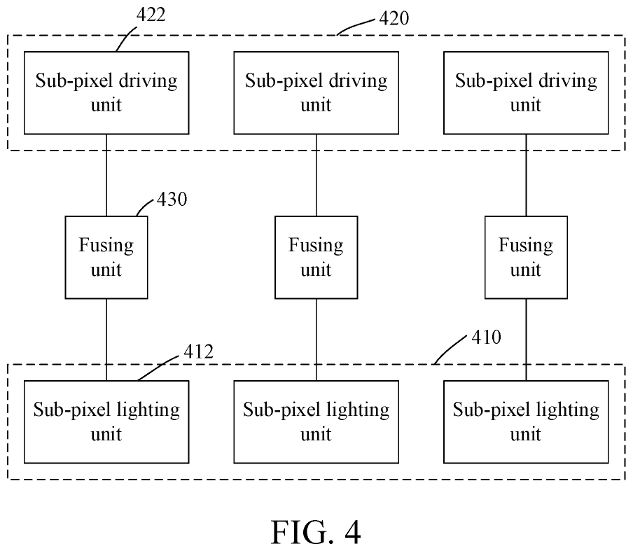

As shown in FIG. 4, a pixel circuit is disclosed. The pixel circuit comprises a lighting unit 410, a pixel driving unit 420, and a fusing unit 430. The lighting unit 410 comprises at least one sub-pixel lighting unit 412. The pixel driving unit 420 comprises at least one sub-pixel driving unit 422. The fusing unit 430 is connected between the sub-pixel driving unit 422 and the anode of the sub-pixel lighting unit 412. When the current outputted from the sub-pixel driving unit 422 is higher than the fusing current threshold, the fusing unit 430 is broken to break the connection between the sub-pixel driving unit 422 and the anode of the sub-pixel lighting unit 412.

In this embodiment, the lighting unit 410 comprises three sub-pixel lighting units 412. The pixel driving unit 420 comprises three sub-pixel driving units 422. Each of the sub-pixel driving units 422 is electrically connected to the anode of each of the sub-pixel lighting 412 in a one-to-one correspondence. Furthermore, there is a fusing unit 430 between each of the sub-pixel driving units 422 and the anode of each of the sub-pixel lighting 412.

Specifically, when the lighting unit 410 comprises three sub-pixel lighting units 412 and the pixel driving unit 420 comprises three sub-pixel driving units 422, the number of the fusing units 430 is also three. That is, each of the sub-pixel driving units 422 is electrically connected to the anode of each of the sub-pixel lighting 412 in a one-to-one correspondence. Furthermore, each of the fusing units 430 is connected between each of the sub-pixel driving units 422 and the anode of each of the sub-pixel lighting 412 in a one-to-one correspondence. Thus, the fusing units could respectively fix the bright dots of the sub-pixel lighting units 412. When one of the sub-pixel lighting unit 412 has a bright dot issue, the output current outputted from the sub-pixel lighting unit 412 is higher than the fusing current threshold and thus a corresponding fusing unit 430 is broken to automatically fix the bright dot. This enormously reduces the repair time of the bright dots and raises the display quality and the manufacturing efficiency.

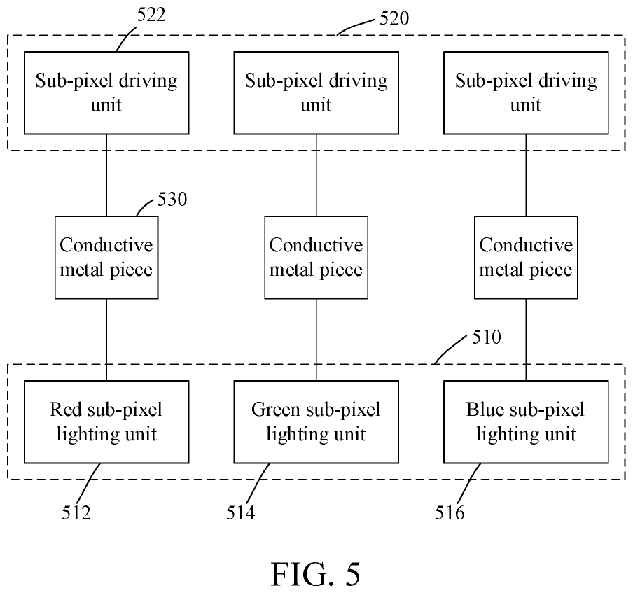

As shown in FIG. 5, a pixel circuit is disclosed. The pixel circuit comprises a lighting unit 510, a pixel driving unit 520 and a fusing unit 530. The lighting unit 510 comprises at least one sub-pixel lighting unit 512. The pixel driving unit 520 comprises at least one sub-pixel driving unit 522. The fusing unit 530 is connected between the sub-pixel driving unit 522 and the anode of the sub-pixel lighting unit 512. When the current outputted from the sub-pixel driving unit 522 is higher than the fusing current threshold, the fusing unit 530 is broken.

The lighting unit 510 comprises a red sub-pixel lighting unit 512, a green sub-pixel lighting unit 514, and a blue sub-pixel lighting unit 516. The sub-pixel driving units 522 are respectively electrically connected to the red sub-pixel lighting unit 512, the green sub-pixel lighting unit 514, and the blue sub-pixel lighting unit 516 in a one-to-one correspondence. The fusing unit 530 is connected between the red sub-pixel lighting unit 512 and the corresponding sub-pixel driving unit 522. The fusing unit 530 is connected between the green sub-pixel lighting unit 514 and the corresponding sub-pixel driving unit 522. The fusing unit 530 is connected between the blue sub-pixel lighting unit 516 and the corresponding sub-pixel driving unit 522.

In the above embodiment, the fusing unit 530 could be used to respectively fix the bright dot of the red sub-pixel lighting unit 512, the green sub-pixel lighting unit 514, and the blue sub-pixel lighting unit 516. When one of the sub-pixel lighting units (the red sub-pixel lighting unit 512, the green sub-pixel lighting unit 514, and the blue sub-pixel lighting unit 516) has a bright dot issue, the output current outputted from the sub-pixel lighting unit (the red sub-pixel lighting unit 512, the green sub-pixel lighting unit 514, and the blue sub-pixel lighting unit 516) is higher than the fusing current threshold and thus a corresponding fusing unit 530 is broken to automatically fix the bright dot. This enormously reduces the repair time of the bright dots and raises the display quality and the manufacturing efficiency.

The sub-pixel lighting unit is an organic light-emitting diode (OLED).

The light emitting diode could be an OLED, a micro-LED, a mini LED or a pLED.

In an embodiment, a display panel is disclosed. The display panel comprises the above-mentioned pixel circuit.

Specifically, the fusing unit is connected between the sub-pixel driving unit and the anode of the sub-pixel lighting unit such that the fusing unit could break the connection between the anode of the sub-pixel lighting unit and the sub-pixel driving unit when the current outputted from the sub-pixel driving unit is higher than a fusing current threshold. This could reduce the above-mentioned issues of bright dots. The present application has a fusing unit between the anode of the sub-pixel lighting unit and the sub-pixel driving unit. This fusing unit could be broken under a high current. Therefore, when the sub-pixel lighting unit has a bright dot issue (this often means that the current is higher than the fusing current threshold), the fusing unit is broken and thus automatically fix the bright dot. This mechanism enormously reduces the repair time of the bright dots and raises the display quality and the manufacturing efficiency.

The configuration of the display panel is similar to the configuration of the pixel circuit and thus further illustration is omitted.

The present application is applied in an OLED display panel. However, this is not a limitation. Actually, the present application could be used in all kinds of current-driven driving display panel, such as micro-OLED display panel or mini LED display panel. The present application could automatically fix the bright dots, enormously reduce the repair time of the bright dots and raise the display quality and the manufacturing efficiency.

In an embodiment, a display device is disclosed. The display device comprises the above-mentioned display panel. The display panel could be an OLED display panel, a micro-LED display panel, a mini LED display panel or a pLED display panel.

Specifically, the fusing unit is connected between the sub-pixel driving unit and the anode of the sub-pixel lighting unit such that the fusing unit could break the connection between the anode of the sub-pixel lighting unit and the sub-pixel driving unit when the current outputted from the sub-pixel driving unit is higher than a fusing current threshold. This could reduce the above-mentioned issues of bright dots. The present application has a fusing unit between the anode of the sub-pixel lighting unit and the sub-pixel driving unit. This fusing unit could be broken under a high current. Therefore, when the sub-pixel lighting unit has a bright dot issue (this often means that the current is higher than the fusing current threshold), the fusing unit is broken and thus automatically fix the bright dot. This mechanism enormously reduces the repair time of the bright dots and raises the display quality and the manufacturing efficiency.

Above are embodiments of the present invention, which does not limit the scope of the present invention. Any modifications, equivalent replacements or improvements within the spirit and principles of the embodiment described above should be covered by the protected scope of the invention.

While the embodiments of the present disclosure have been shown and described above, it is to be understood that the above embodiments are exemplary and are not to be construed as limiting the present disclosure. One of ordinary skill in the art may make variations, modifications, substitutions and alterations to the above embodiments within the scope of the present disclosure.

What is claimed is:

1. A pixel circuit comprising:
a lighting unit, comprising a sub-pixel lighting unit;
a pixel driving unit, comprising a sub-pixel driving unit; and
a fusing unit, electrically connected between the sub-pixel lighting unit and the sub-pixel driving unit;
wherein the fusing unit breaks a connection between the sub-pixel lighting unit and the sub-pixel driving unit when a current outputted by the sub-pixel driving unit is higher than a fusing current threshold.

2. The pixel circuit of claim 1, wherein the sub-pixel driving unit comprises:
a driving thin-film transistor (TFT), having a drain electrically connected to an anode of the sub-pixel lighting unit through the fusing unit.

3. The pixel circuit of claim 2, wherein the sub-pixel driving unit comprises:
a switch driving TFT, having a gate receiving a scan signal, a source receiving a data signal, and a drain electrically connected to a gate of the driving TFT.

4. The pixel circuit of claim 1, wherein the sub-pixel driving unit is a 2T1C driving unit or a 3T1C driving unit.

5. The pixel circuit of claim 1, wherein the fusing unit is a highly conductive metal piece.

6. The pixel circuit of claim 1, wherein the lighting unit comprises three sub-pixel lighting units and the pixel driving unit comprises three sub-pixel driving units; wherein each of the sub-pixel driving units is electrically connected to an anode of each of the sub-pixel lighting unit through a fusing unit in an one-to-one correspondence.

7. The pixel circuit of claim 6, wherein the three sub-pixel lighting units are respectively a red pixel lighting unit, a blue pixel lighting unit, and a green pixel lighting unit.

8. The pixel circuit of claim 1, wherein the sub-pixel lighting unit is an organic light emitting diode (OLED).

9. A display panel, comprising a pixel circuit, the pixel circuit comprising:
a lighting unit, comprising a sub-pixel lighting unit;
a pixel driving unit, comprising a sub-pixel driving unit; and
a fusing unit, electrically connected between the sub-pixel lighting unit and the sub-pixel driving unit;
wherein the fusing unit breaks a connection between the sub-pixel lighting unit and the sub-pixel driving unit when a current outputted by the sub-pixel driving unit is higher than a fusing current threshold.

10. The display panel of claim 9, wherein the sub-pixel driving unit comprises:
a driving thin-film transistor (TFT), having a drain electrically connected to an anode of the sub-pixel lighting unit through the fusing unit.

11. The display panel of claim 10, wherein the sub-pixel driving unit comprises:
a switch driving TFT, having a gate receiving a scan signal, a source receiving a data signal, and a drain electrically connected to a gate of the driving TFT.

12. The display panel of claim 9, wherein the sub-pixel driving unit is a 2T1C driving unit or a 3T1C driving unit.

13. The display panel of claim 9, wherein the fusing unit is a highly conductive metal piece.

14. The display panel of claim 9, wherein the lighting unit comprises three sub-pixel lighting units and the pixel driving unit comprises three sub-pixel driving units; wherein each of the sub-pixel driving units is electrically connected to an anode of each of the sub-pixel lighting unit through a fusing unit in an one-to-one correspondence.

15. The display panel of claim 14, wherein the three sub-pixel lighting units are respectively a red pixel lighting unit, a blue pixel lighting unit, and a green pixel lighting unit.

16. The display panel of claim 9, wherein the sub-pixel lighting unit is an organic light emitting diode (OLED).

17. A display device, comprising a display panel having a pixel circuit, the pixel circuit comprising:
a lighting unit, comprising a sub-pixel lighting unit;
a pixel driving unit, comprising a sub-pixel driving unit; and
a fusing unit, electrically connected between the sub-pixel lighting unit and the sub-pixel driving unit;
wherein the fusing unit breaks a connection between the sub-pixel lighting unit and the sub-pixel driving unit when a current outputted by the sub-pixel driving unit is higher than a fusing current threshold.
